(19) United States
(12) Patent Application Publication
(10) Pub. No.: US 2013/0342946 A1
(43) Pub. Date: Dec. 26, 2013

(54) PARALLEL PROTECTION CIRCUIT FOR SOLAR MODULE

(71) Applicants: Lei Qu, Suzhou City (CN); Tong Wang, Suzhou City (CN); Haibing Gao, Suzhou City (CN)

(72) Inventors: Lei Qu, Suzhou City (CN); Tong Wang, Suzhou City (CN); Haibing Gao, Suzhou City (CN)

(21) Appl. No.: 14/004,080

(22) PCT Filed: Mar. 6, 2012
(86) PCT No.: PCT/CN2012/071966

§ 371 Date: Sep. 9, 2013

(30) Foreign Application Priority Data
Mar. 10, 2011 (CN) 201110057871.3

(51) Int. Cl. H02H 3/00

(52) U.S. Cl. CPC H02H 3/003
USPC 361/91.6

(57) ABSTRACT

A parallel protection circuit for a solar module, comprising a field effect transistor for blocking current reversal, a driver module for driving the field effect transistor, and a protection module for preventing the gate of the field effect transistor from high-voltage puncturing. The driver module and the protection module are serially connected to each other to form the control module of the parallel protection circuit, and the control module is connected in parallel with the solar module at two output polarities of the solar module. The gate of the field effect transistor is connected between the driver module and the protection module, the source terminal of the field effect transistor is connected to the negative terminal of the solar module, and the drain terminal of the field effect transistor and the positive terminal of the solar module form two protected output polarities. The protection module may be a resistance, a diode string, or a Zener diode, and so on. The parallel protection circuit reduces the loss in a solar module protection circuit, thereby enhancing the power generation capacity of a solar cell in the early morning, evening and rainy days. In addition, the present invention has the characteristics of simple structure, great versatility, low production cost, and can play a significant role in promoting solar energy applications.

### TECHNICAL FIELD

The present invention relates to a circuit design of a solar module application, especially relates to a parallel protection circuit with a failure detection indicator module added for preventing the solar module from reverse current puncturing, enhancing output power of the solar module.

### BACKGROUND ART

As a renewable energy, solar energy has become increasingly popular and is widely used in people's daily life and daily work. Wherein, the most direct application is converting solar energy into electrical energy. The radiant energy of the sun is collected through the solar cell in the daytime and then converted and output, whereas in the early morning, evening or rainy days when the radiant energy of the sun is weak, the output voltage of the solar cell will reduce, if there is no solar cell protection circuit, the supplement current supplied from storage batteries or other power sources in the output line will flow back to the solar cell causing the cell life shortened and electricity loss.

Meanwhile, under the situation of several solar cells in parallel operation: since every solar cells are located at different geographic positions, they are exposed to different amounts of sunlight and have different shadow areas, along with sometimes that some of the solar cells are broken, all of these situations will cause the output voltage of some solar cells getting lower or even no output. If there is no protection circuit, current will flow back to those solar cells having lowered output voltages or no output, thereby resulting in power loss and the shadowed solar cells broken. Therefore, it is necessary to take protective measures at the output of the solar cell to block current reversal (as shown in FIG. 1).

In the prior art, the severity of said problem mentioned above has already been aware of, and some solutions have been proposed accordingly. However, these solutions generally adopted valuable components as an essential component unit of the protection circuit, such as operational amplifiers, microprocessor chips and so on, these components require an external drive power supply, and usually the output voltage of the solar cell is higher than the voltage of the external drive power supply of said components, which, to a certain extent, limit the driving performance for other components in the protection circuit and greatly increase the production cost of solar module protection.

At present a common application method is: the protection component connected to the solar cell usually uses a diode to block current reversal and avoid the electricity loss based on the working principle of the diode that it is conductive when connected in a forward direction and non-conductive when connected in a reverse direction. But since the forward voltage drop of the diode is 0.7V, the output voltage and efficiency is reduced, and since the effective output voltage of the solar cell is reduced, the effective power generating time during the day is shortened, resulting in that the actual power output of the solar cell is reduced greatly. According to the estimate of the 12V solar cell, 11% of the power generating capacity will be lost each year, which increases the solar energy generating cost and limits the promotion of the new energy.

### SUMMARY OF THE INVENTION

In view of the defects existing in the prior art mentioned above, an object of the present invention is to provide a parallel protection circuit for a solar module to improve the power generation capacity and energy efficiency of the solar module during nights and rainy days, and to reduce the application cost of the protection circuit.

The object of the present invention is achieved by the following technical solutions:

A parallel protection circuit for a solar module, wherein, said parallel protection circuit comprises a field effect transistor for blocking current reversal, a driver module for driving the field effect transistor, and a protection module for preventing a gate of the field effect transistor from high-voltage puncturing, wherein, said driver module and said protection module are serially connected to each other to form a control module of the parallel protection circuit, and the control module is connected in parallel with the solar module at two output polarities of the solar module; and the gate of said field effect transistor is connected between the driver module and the protection module, a source terminal of the field effect transistor is connected to a negative terminal of the solar module, and a drain terminal of the field effect transistor and a positive terminal of the solar module form two protected output polarities; the protection module comprises at least one of a resistance, a resistance string, a diode, a diode string, and a Zener diode, or any combination thereof.

Preferably, said control module comprises a resistance C as the driver module and a resistance H1 as the protection module, and values of said two resistances meet the formula: R_{H1}: R_{C}=U_{G}: (U_{PV}−U_{G}), wherein, U_{G} is drive voltage of the gate of the field effect transistor, U_{PV} is output voltage of the solar module.

Preferably, said control module comprises a resistance C as the driver module and a diode string H2 as the protection module, and quantity of diodes comprised in said diode string H2 matches with the multiple of the drive voltage of the gate of the field effect transistor relative to voltage drop on a single diode.

Preferably, said control module comprises a resistance C as the driver module and a Zener diode H3 as the protection module, and the stabilized voltage value of said Zener diode is between the drive voltage value of the gate of the field effect transistor and puncture voltage value of the gate of the field effect transistor. Moreover, said parallel protection circuit further comprises a failure detection indicator module.

Wherein, the failure detection indicator module herein may be a light-emitting diode, and said light-emitting diode is connected in a forward direction between the source terminal of the field effect transistor and the drain terminal of the field effect transistor;

Wherein, the failure detection indicator module herein also may be a light-emitting diode driven by a triode, wherein, a base and an emitter of said triode are respectively connected to the source terminal and the drain terminal of the field effect transistor, and said light-emitting diode is connected in a reverse direction between a collector of the triode and the positive terminal of the solar module.

Wherein, the failure detection indicator module herein also may be based on a triode, a base and an emitter of said triode are respectively connected to the source terminal and the drain terminal of the field effect transistor, and a collector of the triode is externally connected for output testing.

The present invention provides a new parallel protection circuit, which greatly reduces the loss in a solar module and improves the power generation capacity of a solar cell. The present invention improves the system redundancy and the output power, at the same time, enhances the power generation capacity of a solar cell in the early morning, evening and rainy days. In addition, the present invention has the characteristics of simple structure, great versatility, low production cost, and can play a significant role in promoting solar energy applications.

### BRIEF DESCRIPTION OF THE DRAWINGS

FIG. 1 is a schematic diagram illustrating the topology structure of several solar cells in parallel operation;

FIG. 2 is a schematic diagram illustrating the parallel protection circuit of the prevent invention;

FIG. 3a is a schematic circuit diagram illustrating the parallel protection circuit according to one embodiment of the present invention;

FIG. 3b is a schematic circuit diagram illustrating the parallel protection circuit according to another embodiment of the present invention;

FIG. 3c is a schematic circuit diagram illustrating the parallel protection circuit according to another embodiment of the present invention;

FIG. 4 is a schematic diagram illustrating the further function evolution of the parallel protection circuit on the basis of that shown the FIG. 2;

FIG. 5a is a schematic circuit diagram illustrating an implementation of the failure detection indicator module as shown in FIG. 4;

FIG. 5b is a schematic circuit diagram illustrating another implementation of the failure detection indicator module as shown in FIG. 4;

FIG. 5c is a schematic circuit diagram illustrating another implementation of the failure detection indicator module as shown in FIG. 4.

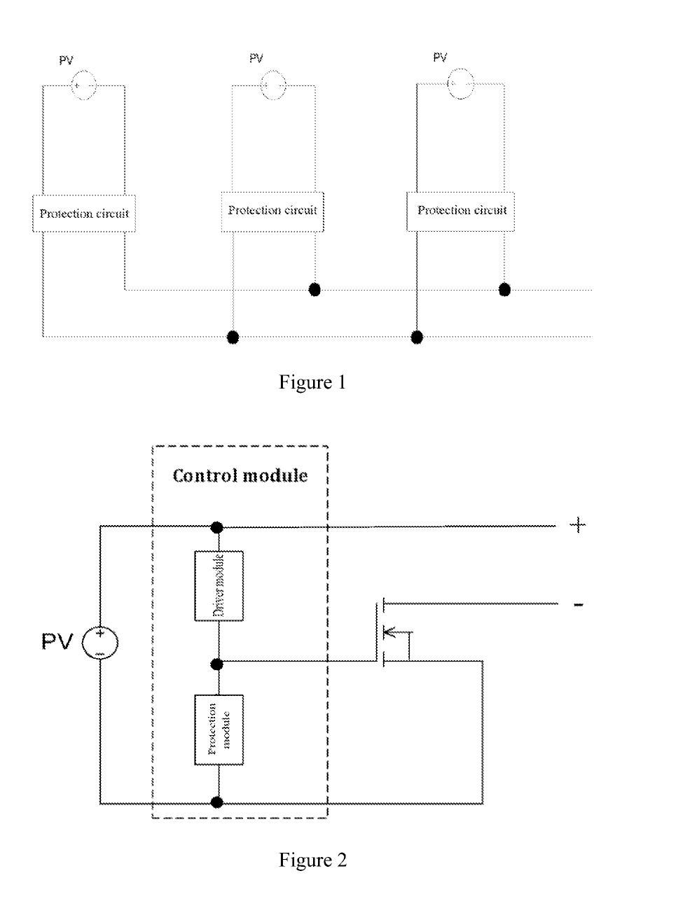

### DETAILED DESCRIPTION OF THE PREFERRED EMBODIMENTS

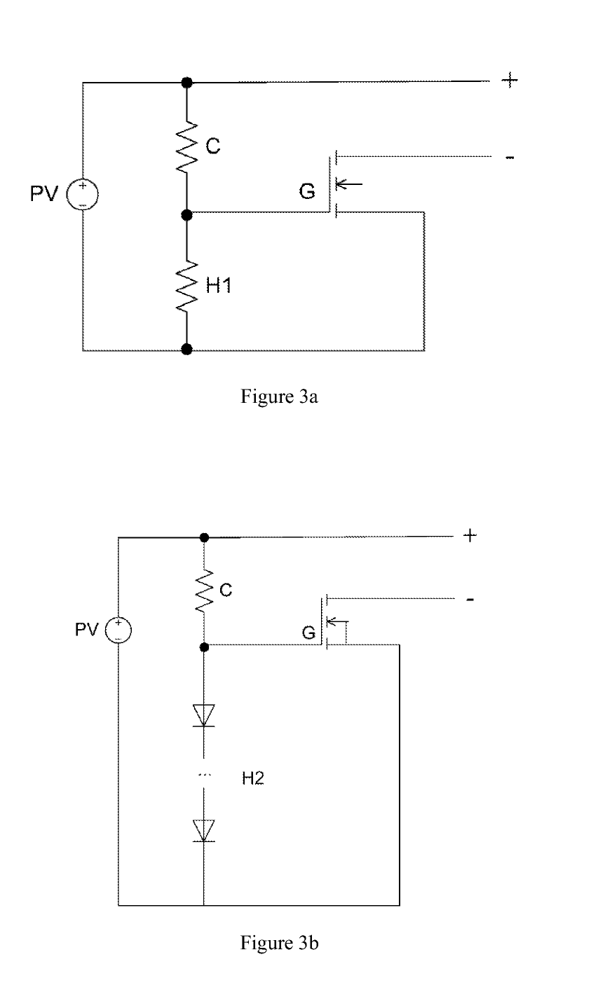

The present invention provides a new protection circuit for the solar module (or solar cell), comprising a field effect transistor for blocking current reversal, and a control module which comprises a driver module for driving the field effect transistor and a protection module for preventing over-voltage in the gate of the field effect transistor. The specific circuit connecting relationship is: said driver module and protection module are serially connected to each other to form the control module of the parallel protection circuit, and the control module is connected in parallel with the solar module at two output polarities of the solar module. The gate of the field effect transistor is connected between the driver module and the protection module, the source terminal of the field effect transistor is connected to the negative terminal of the solar module, and the drain terminal of the field effect transistor and the positive terminal of the solar module form two protected output polarities (as shown in FIG. 2). Said protection module comprises at least one of a resistance, a resistance string, a diode, a diode string, and a Zener diode, or any combinations thereof. As shown in the figures: under the normal working state of the PV module, a forward voltage drop exists between the positive polarity and negative polarity thereof, the voltage drop is applied to two ends of the whole control module. Then said forward voltage drop is applied to the gate of the field effect transistor via the driver module of said control module to forward conduct the field effect transistor, so as to allow the current returning to the negative polarity of the solar cell from the output negative polarity, thereby forming a current loop to ensure the normal output of the solar cell. Meanwhile, the drive voltage of the gate is limited by the protection module of the control module to ensure that the drive voltage value of the gate is not beyond the puncture voltage value of the gate, thereby preventing the field effect transistor from puncturing by excessive output voltage generated because of too small load or overlarge power output.

In the present invention, since the control module comprises a protection module for limiting the voltage, all of three terminals of the field effect transistor can be within the safe working voltage range, thereby being suitable for output voltages of different solar modules.

The preferred embodiments of the present invention will be described in more details with reference to the accompanying drawings so that the technical solutions of the present invention will be understood and employed more easily.

### Embodiment 1

### A Control Module Consisting of Two Resistances

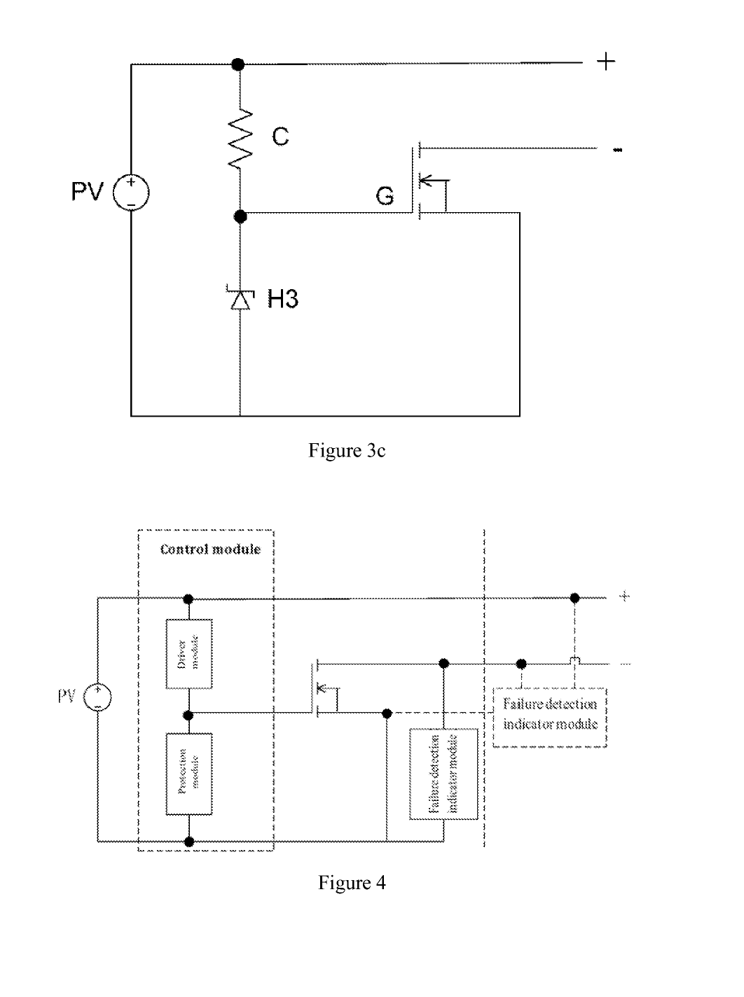

As shown in FIG. 3a, said control module comprises a resistance C as the driver module and a resistance H1 as the protection module, the two resistances are serially connected to each other, and the values of said two resistances meet the formula: R_{H1}: R_{C}=U_{G}: (U_{PV}−U_{G}), wherein, U_{G} is the drive voltage of the gate of the field effect transistor, U_{PV} is the output voltage of the solar module. For example, when the drive voltage value U_{G} is 2V and the PV output voltage value U_{PV} is 12V, the calculation result of the rate of the resistances R_{H1}:R_{C} is equal to 1:5. The larger is the resistance, the less is the current through said resistance, and the less is the power loss. However, the resistance value can not be too large because overlarge resistance could cause controlling instability, and the current should be large enough to drive the gate of the field effect transistor. Said embodiment 1 has the characteristic of simple principle, lowest cost and higher reliability within the applicable voltage range, but said control module has a larger power loss. Meanwhile, since the voltage value of the gate of the filed effect transistor changes proportionally with the change of the PV output voltage, when the PV output voltage is so small that causing the voltage value of the gate lower than the drive voltage value of the gate of the field effect transistor, said field effect transistor will be turned off, thereby limiting the minimum value of the output voltage.

Different ratios of the resistances are selected according to requirements of different PV output voltages, and said embodiment is suitable for cost priority application fields.

### Embodiment 2

### A Control Module Consisting of One Resistance and Several Diodes Serially Connected

As shown in FIG. 3b, in said embodiment 2, still one resistance C is adopted as the driver module but several diodes are serially connected to form the diode string H2 as the protection module, wherein, the voltage drop of each diode comprised herein is 0.7V, and the quantity of diodes matches with the multiple of the drive voltage of the gate of the field effect transistor relative to voltage drop on a single diode, which means that in said embodiment 2, by changing the quantity of diodes, the drive voltage of the gate of the field effect transistor can be controlled and substantively maintained at a fixed voltage value.

Said embodiment 2 adopts the stable junction voltage of the diode to steady the drive voltage of the gate, so that the control module can accommodate to different kinds of PV and has the characteristic of great versatility.

### Embodiment 3

### A Control Module Consisting of a Resistance and a Zener Diode

As shown in FIG. 3c, in said embodiment 3, a resistance C is adopted as the driver module and a Zener diode H3 is adopted as the protection module. The stabilized voltage value of the Zener diode H3 is determined by the drive voltage value of the field effect transistor, usually the stabilized voltage value is set higher than the drive voltage value and capable of ensuring the field effect transistor to work in a completely conducting state, but not beyond the puncturing voltage of said gate. The stabilized voltage value is steadied by the leakage current. As to the driver circuit, there is no high requirement for selecting the resistance C, but just satisfying the requirements of the drive current of the field effect transistor. The embodiment has the characteristic of sample circuit, great versatility, being stable and reliable, and capable of accommodating to a variety of application requirements.

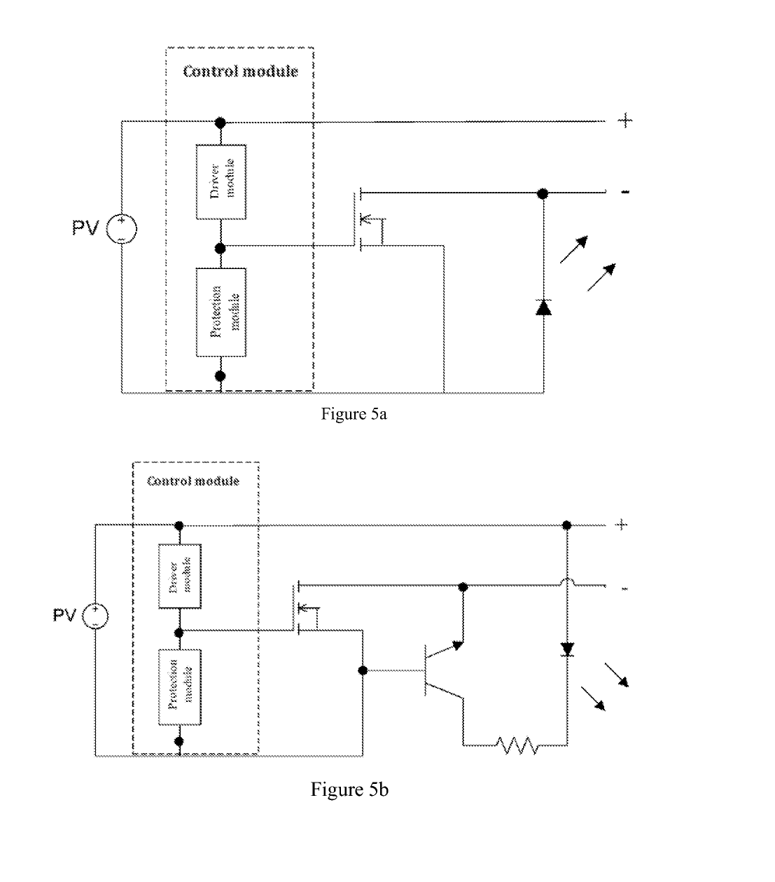

In normal working hour, the voltage drop of the field effect transistor is about 0.02V, which means that, the voltage value of the PV negative terminal is 0.02V lower than the voltage value of the output negative terminal, while in case of failures, the voltage value of the PV output is lower than the voltage drop of the output line, therefore, the voltage value of the PV negative terminal is higher than the voltage value of the output line. That is, in normal working hour, the forward voltage drop of the field effect transistor is 0.02V, while in case of failures, the voltage drop between the two ends of the field effect transistor is changed to a reverse voltage drop. Taking advantages of this phenomenon, the failure detection indicating can be realized. As shown in FIG. 4, it is a schematic diagram illustrating the further function evolution of the present invention after the failure detection indicator module is added. According to different indicating requirements, said failure detection indicator module can be implemented in diversified manners, for instance, said detection indicator may be connected to the output negative terminal of the whole solar module, alternatively, it may be connected between the positive terminal and negative terminal of the whole solar module. More details will be described as follows:

### Embodiment 4

### Simple Failure Indicating Realized by a Light-Emitting Diode

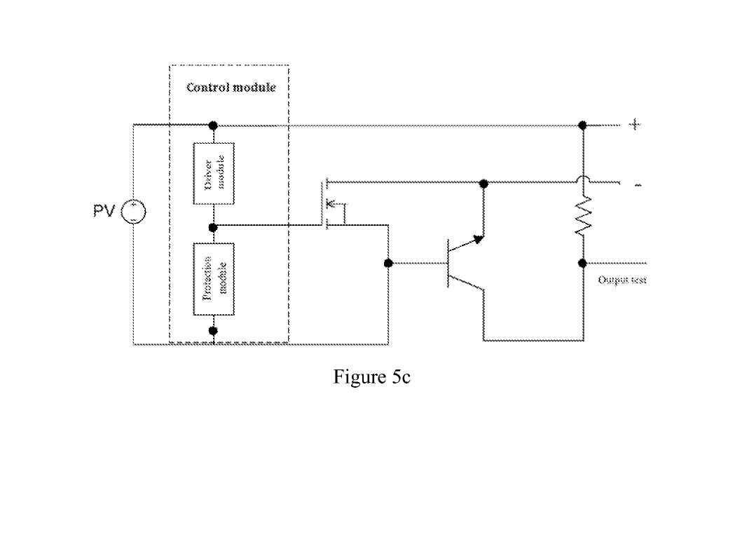

As shown in FIG. 5a, said failure detection indicator module is a light-emitting diode, connected in a forward direction between the source terminal and the drain terminal of the field effect transistor. The failure indicating of said embodiment 4 is suitable for the situation with higher PV working voltage, and can simply indicate the PV failure within a limited range, however, it cannot indicate the failure effectively in case the output voltage is slightly reduced due to that the PV is shadowed. Therefore, said embodiment 4 is suitable for low-cost applications.

### Embodiment 5

### Failure Indicating Realized by a Light-Emitting Diode Driven by a Triode

As shown in FIG. 5b, the failure detection indicator module in said embodiment 5 is a light-emitting diode driven by a triode, wherein, the base and the emitter of said triode are respectively connected to the source terminal and the drain terminal of the field effect transistor, and said light-emitting diode is connected in a reverse direction between the collector of the triode and the positive terminal of the solar module. The failure detection indicator module in said embodiment 5 through adopting a light-emitting diode driven by a triode, the indicating effect has been enhanced, on the other hand, the indicating range has been extended, and the light-emitting diode can be lighted up to indicate failures effectively when the PV output voltage is at least 0.3V less than the output line voltage.

### Embodiment 6

### The Failure Detection Output

As shown in FIG. 5c, said failure detection indicator module is based on a triode, the base and the emitter of said triode are respectively connected to the source terminal and the drain terminal of the field effect transistor, and the collector of the triode is externally connected for output testing. In said embodiment 6, a status signal can be obtained and provided to the superior control system to detect the working status of each PV.

According to the detailed description for the circuit with reference to the accompanying preferred embodiments, the substantial characteristics of the present invention have been shown clearly, and the progress thereof is obvious: the loss in a solar module protection circuit is significantly reduced, the system redundancy and output power of the solar module are improved, and the power generation capacity of the solar module during nights and rainy days is enhanced; in addition, the present invention has the characteristics of simple structure, great versatility, low production cost, and can play a significant role in promoting solar energy applications.

It should be understood that the purpose of the detailed description for the preferred embodiments with reference to the accompanying drawings is to ensure that those skilled in the art can deeply understand and employ the substantial characteristics, the implementing criterion and the outstanding effects thereof, but not for limiting the present invention. Therefore, those technical solutions that are equivalent replaced or simply modified based on preferred embodiments and accompanying drawings herein, which solve the same technical issues and achieve the same technical effects, should be seen in the scope of the present invention.

What is claimed is:

1. A parallel protection circuit for a solar module, wherein, said parallel protection circuit comprises a field effect transistor for blocking current reversal, a driver module for driving the field effect transistor, and a protection module for preventing a gate of the field effect transistor from high-voltage puncturing, wherein, said driver module and said protection module are serially connected to each other to form a control module of the parallel protection circuit, and the control module is connected in parallel with the solar module at two output polarities of the solar module; and the gate of said field effect transistor is connected between the driver module and the protection module, a source terminal of the field effect transistor is connected to a negative terminal of the solar module, and a drain terminal of the field effect transistor and a positive terminal of the solar module form two protected output polarities; the protection module comprises at least one of a resistance, a resistance string, a diode, a diode string, and a Zener diode, or any combination thereof.

2. The parallel protection circuit for a solar module according to claim 1, wherein, said control module comprises a resistance C as the driver module and a resistance H1 as the protection module, and values of said two resistances meet the formula: R_{H1}: R_{C}=U_{G}: (U_{PV}−U_{G}), wherein, U_{G} is drive voltage of the gate of the field effect transistor, U_{PV} is output voltage of the solar module.

3. The parallel protection circuit for a solar module according to claim 1, wherein, said control module comprises a resistance C as the driver module and a diode string H2 as the protection module, and quantity of diodes comprised in said diode string H2 matches with the multiple of the drive voltage of the gate of the field effect transistor relative to voltage drop on a single diode.

4. The parallel protection circuit for a solar module according to claim 1, wherein, said control module comprises a resistance C as the driver module and a Zener diode H3 as the protection module, and stabilized voltage value of said Zener diode is between the drive voltage value of the gate of the field effect transistor and puncture voltage value of the gate of the field effect transistor.

5. The parallel protection circuit for a solar module according to claim 1, wherein, said parallel protection circuit further comprises a failure detection indicator module.

6. The parallel protection circuit for a solar module according to claim 5, wherein, said failure detection indicator module is a light-emitting diode, and said light-emitting diode is connected in a forward direction between the source terminal of the field effect transistor and the drain terminal of the field effect transistor.

7. The parallel protection circuit for a solar module according to claim 5, wherein, said failure detection module is a light-emitting diode driven by a triode, wherein, a base and an emitter of said triode are respectively connected to the source terminal and the drain terminal of the field effect transistor, and said light-emitting diode is connected in a reverse direction between a collector of the triode and the positive terminal of the solar module.

8. The parallel protection circuit for a solar module according to claim 5, wherein, said failure detection indicator module is based on a triode, a base and an emitter of said triode are respectively connected to the source terminal and the drain terminal of the field effect transistor and a collector of the triode is externally connected for output testing.
